(19) United States
(12) Patent Application Publication
(10) Pub. No.: US 2015/0381418 A1
(43) Pub. Date: Dec. 31, 2015

(54) Remote Orchestration of Virtual Machine Updates

(71) Applicant: iPhotonix, Richardson, TX (US)

(72) Inventors: Louis Gregory Fausak, Parker, TX (US); Andrew Kennedy Fullford, Dallas, TX (US)

(21) Appl. No.: 14/749,231

(22) Filed: Jun. 24, 2015

Related U.S. Application Data
(60) Provisional application No. 62/018,411, filed on Jun. 27, 2014.

(51) Int. Cl. H04L 12/24; H04L 29/08

(52) U.S. Cl. CPC H04L 41/0813; H04L 67/141

(57) ABSTRACT

Virtual machines can be remotely configured on distributed host devices by communicating management instructions over remote access tunnels. The management instructions prompt virtual remote agents on instantiated on the distributed host devices to configure virtual machines on the distributed host devices. The management instruction may prompt the virtual remote agents to instantiate a new virtual machine, to re-configure an existing virtual machine, or to create, remove, and/or modify virtual paths between two or more virtual machines on the distributed host device. Management signaling can be broadcast over multiple management tunnels to coordinate the configuration of multiple virtual machines at different distributed host devices based on a single virtual machine installation instance in an MSP server.

This patent application claims priority to U.S. Provisional Application No. 62/018,411, filed on Jun. 27, 2014 and entitled “Remote Orchestration of Virtual Machine Updates,” which is hereby incorporated by reference herein as if reproduced in its entirety.

### CROSS-REFERENCE TO RELATED APPLICATIONS

This patent application is related to U.S. patent application Ser. No. 14/749,081, U.S. patent application Ser. No. 14/749,163, U.S. patent application Ser. No. 14/749,317, and U.S. patent application Ser. No. 14/749,365, each of which are incorporated by reference herein as if reproduced in their entireties.

### TECHNICAL FIELD

The present invention relates generally to telecommunications, and in particular embodiments, to techniques and mechanisms for remote orchestration of virtual machine updates.

### BACKGROUND

Small and medium businesses (SMBs) are becoming increasingly data intensive as industries adapt to the information age. This has created a demand for cost-effective network solutions capable of efficiently delivering services across distributed locations in a secure and reliable manner. Notably, conventional enterprise networks are designed primarily for large corporations, and may be ill-suited for many SMB applications. Specifically, conventional enterprise networks typically require technical support at the network edge in order to deploy and service network equipment in remote office locations. Since many SMB clients do not employ on-site information technology (IT) personnel, the deployment and maintenance of conventional enterprise network equipment in SMB remote offices may require service calls by certified technicians, which may significantly increase the up-front and/or operational expenses of providing conventional enterprise networks to SMB clients. Accordingly, techniques and systems for providing affordable, yet capable, network solutions to SMB clients are desired.

### SUMMARY OF THE INVENTION

Technical advantages are generally achieved, by embodiments of this disclosure which describe for remote orchestration of virtual machine updates.

In accordance with an embodiment, a method for remotely managing distributed hosts of a virtual edge router is provided. In this example, the method includes establishing a management tunnel between a wide area network (WAN) interface of a management server and a wide area network (WAN) interface of a distributed host device. The management tunnel extends through a public internet. The method further includes sending a management instruction over the management tunnel to a virtual remote agent instantiated on the distributed host device. The management instruction prompts the virtual remote agent to autonomously configure at least one virtual machine on the distributed host device without direct interaction between a user and the distributed host device. An apparatus for performing this method is also provided.

In accordance with another embodiment, a method for coordinating establishment of virtual machines at distributed locations of a virtual edge network is provided. In this example, the method comprises creating a single virtual machine installation instance at a management server, and broadcasting a management instruction over management tunnels of the virtual edge network to a set of virtual remote agents. Each virtual remote agent in the set of virtual remote agents is instantiated on a different one of a plurality of distributed host devices. The broadcast management instruction specifies instantiation instructions for the single virtual machine installation instance. The broadcast management instruction prompts each virtual remote agent in the set of virtual remote agents to autonomously instantiate a virtual machine on a corresponding one of the plurality of distributed host devices based on the single virtual machine installation instance. An apparatus for performing this method is also provided.

In accordance with yet another embodiment, a method for coordinating updates to virtual machines at distributed locations of a virtual edge network is provided. In this example, the method comprises identifying a single virtual machine installation instance stored at the management server. The single virtual machine installation instance corresponds to a set of virtual machines each of which being instantiated on a different one of a plurality of distributed host devices. The method further includes reconfiguring the single virtual machine installation instance at the management server to obtaining a reconfigured virtual machine installation instance. The method further includes broadcasting a management instruction over management tunnels of the virtual edge network to a set of virtual remote agents. Each virtual remote agent in the set of virtual remote agents is instantiated on a different one of the plurality of distributed host devices. The broadcast management instruction specifies reconfiguration instructions for the reconfigured virtual machine installation instance. The broadcast management instruction prompts each virtual remote agent in the set of virtual remote agents to autonomously update a corresponding virtual machine in the set of virtual machines. An apparatus for performing this method is also provided.

### BRIEF DESCRIPTION OF THE DRAWINGS

For a more complete understanding of the present disclosure, and the advantages thereof, reference is now made to the following descriptions taken in conjunction with the accompanying drawings, in which:

FIGS. 1A-1E illustrate diagrams of an embodiment virtual edge router network;

FIG. 2 illustrates a diagram of another embodiment virtual edge router networks;

FIG. 3 illustrates a diagram of an embodiment virtual architecture for a distributed host device;

FIG. 4 illustrates a diagram of another embodiment virtual architecture for a distributed host device;

FIG. 5 illustrates a diagram of an embodiment virtual edge router adapted for remote configuration of virtual machines on distributed host devices;

FIG. 6 illustrates a diagram of an embodiment communications sequence 600 for remotely configuring virtual machines on distributed host devices;

FIG. 7 illustrates a flowchart of an embodiment method for remotely triggering the instantiation of a virtual machine on a distributed host device;

FIG. 8 illustrates a flowchart of an embodiment method remotely triggering the modification of a virtual machine instantiated on a distributed host device;

FIG. 9 illustrates a diagram of an embodiment communications sequence 600 for remotely coordinating the instantiation of virtual machines on distributed host devices;

FIG. 10 illustrates a flowchart of an embodiment method remotely triggering the instantiation of virtual machines on distributed host devices;

FIG. 11 illustrates a diagram of an embodiment computing platform; and

FIG. 12 illustrates a diagram of an embodiment communications device.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims. While much of this disclosure discusses virtual networking solutions for SMB clients, those of ordinary skill in the art will recognize that the underlying concepts are scalable to any size system, including (but not limited to) large enterprise networks. Various concepts are disclosed in U.S. Provisional Patent Application 62/018,350, U.S. Provisional Patent Application 62/018,389, U.S. Provisional Patent Application 62/018,398, U.S. Provisional Patent Application 62/018,408, U.S. Provisional Patent Application 62/018,421, U.S. Provisional Patent Application 62/018,433, U.S. Provisional Patent Application 62/018,443 are, each of which are incorporated by reference herein as if reproduced in their entireties.

Innovative virtual networking architectures are described by U.S. patent application Ser. No. 14/749,081. As described therein, embodiment virtual edge routers include virtual machines instantiated on host devices positioned at remote office locations of an SMB client, as well as well as a data plane that communicatively couples the virtual data forwarding units to one another. In some situations, SMB clients may want to remotely access a distributed host device for purposes of configuring virtual machines instantiated thereon. Moreover, SMB clients having several distributed host devices with overlapping functionality requirements may want to instantiate the same virtual machine on each of those hosts. For example, an SMB client having a large number of distributed hosts, e.g., fifty or more, may want to coordinate the instantiation of a virtual machine instance on each of the devices without having to individually configure each one. The SMB client may also want to coordinate the modification of those instances.

Aspects of this disclosure provide mechanisms for remotely configuring virtual machines on distributed host devices. Embodiment remote configuration techniques transport management signaling over management tunnels extending from a managed service provider (MSP) server to virtual remote agents instantiated on the distributed host devices. The management signaling may include management instructions that prompt the virtual remote agents to configure virtual machines on the distributed host devices. For example, the management instruction may prompt a virtual remote agent to instantiate a new virtual machine, to re-configure an existing virtual machine, or to create, remove, and/or to modify virtual paths between two or more virtual machines on a distributed host device. Moreover, management signaling can be broadcast over multiple management tunnels to coordinate the configuration of multiple virtual machines at different distributed host devices based on a single virtual machine installation instance in an MSP server. For example, the broadcast management instructions may coordinate the instantiation of new virtual machines when a new virtual machine installation instance is created at the MSP server. As another example, the broadcast management instructions may trigger orchestrated updating of existing virtual machines when a virtual machine installation instance is reconfigured at the MSP server. These and other aspects of this disclosure are described in greater detail below.

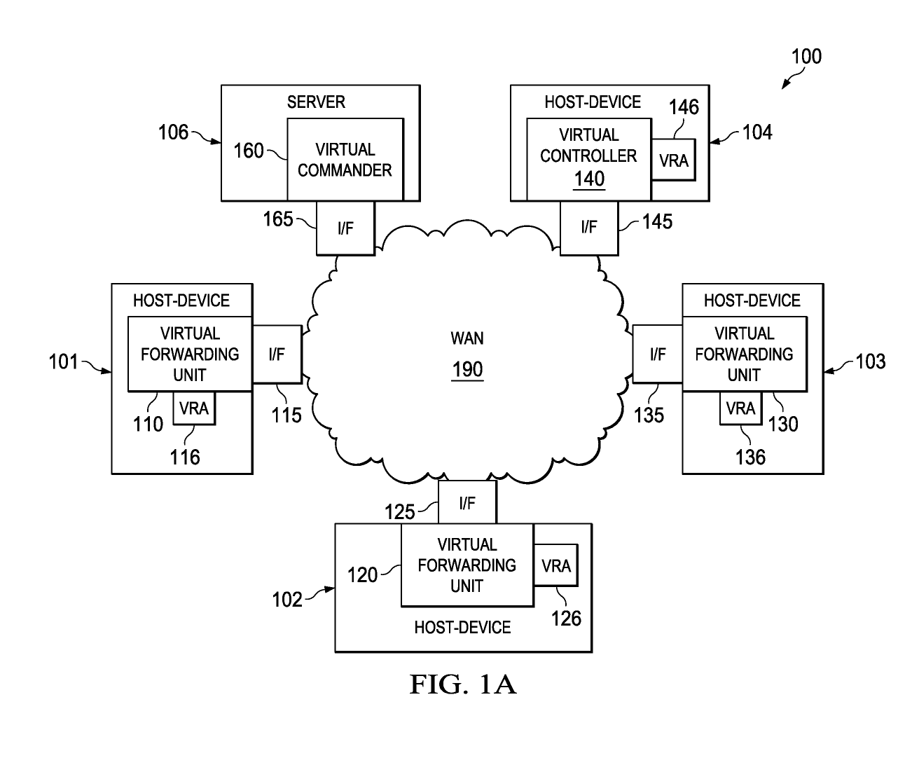

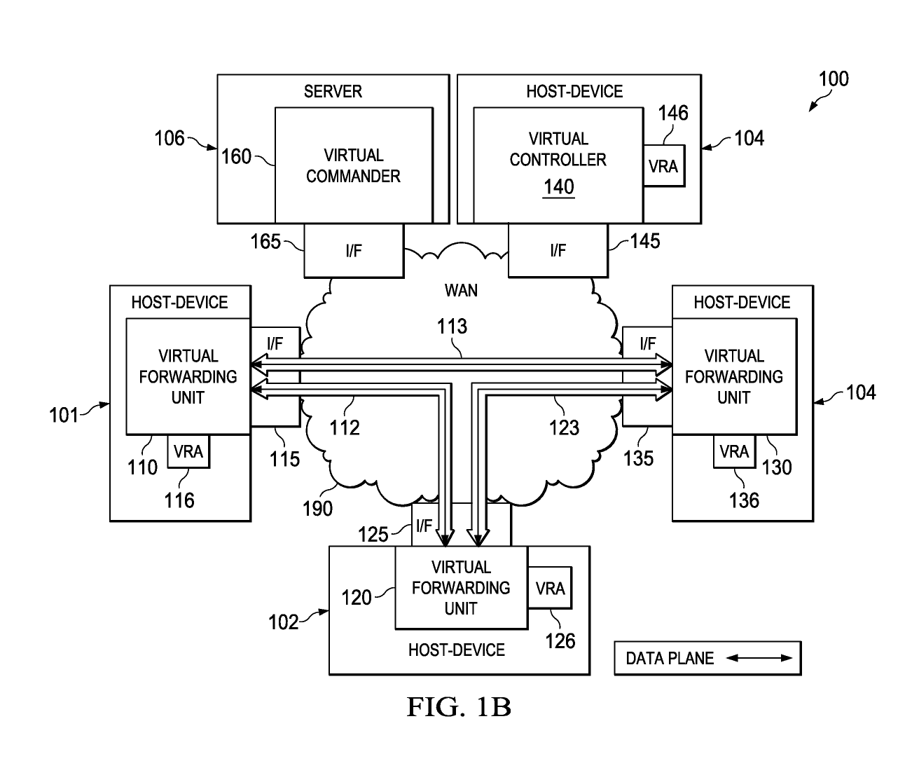

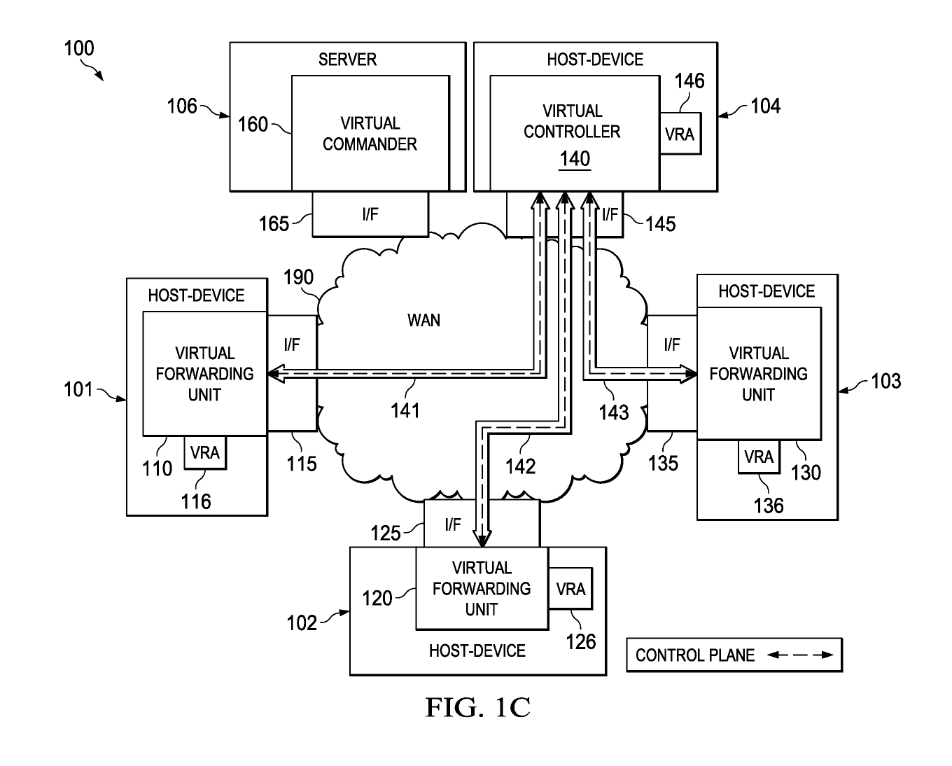

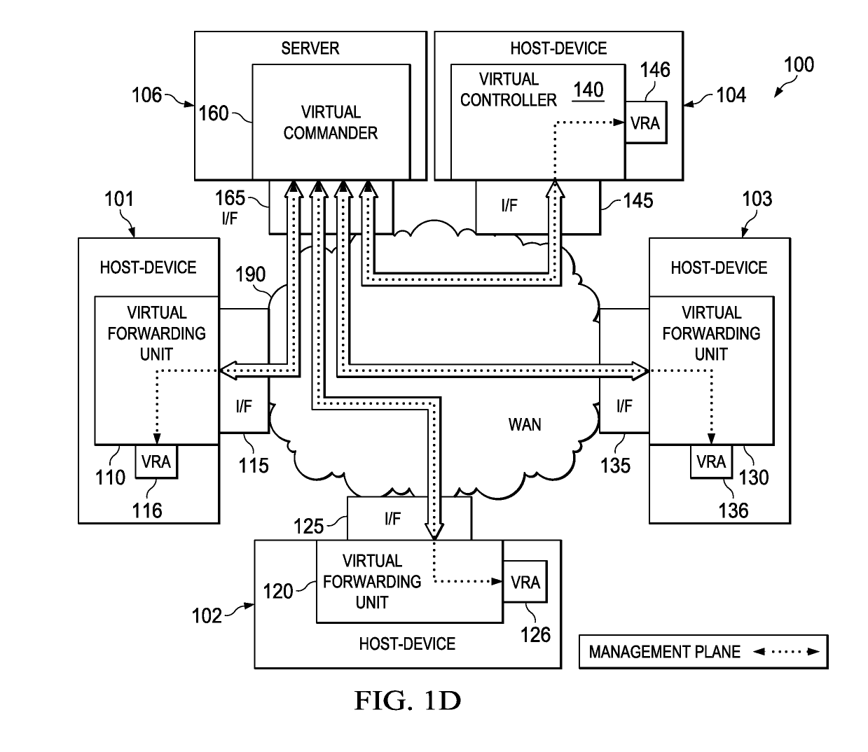

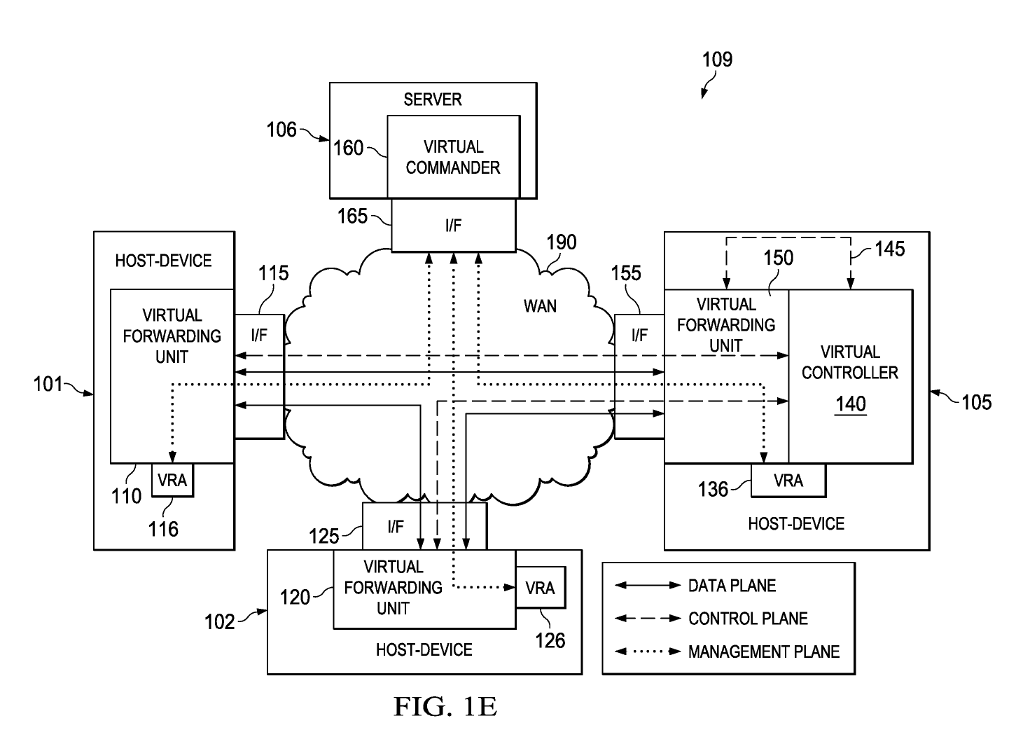

FIGS. 1A-1D illustrate a virtual edge router 100 comprising a plurality of virtual data forwarding units 110, 120, 130, a virtual controller 140, and a plurality of virtual remote agents 116, 126, 136, 146. The virtual forwarding units 110, 120, 130, the virtual controller 140, and the virtual remote agents 116, 126, 136, 146 (referred to collectively as “virtual components”) may comprise any hardware, software, or combinations thereof within the host devices 101-104. For example, one or more of the virtual components 110-146 may be a virtual machine instantiated on a corresponding one of the host devices 101-104. As another example, one or more of the virtual components 110-146 may be a dedicated hardware component (e.g., application-specific integrated circuits (ASICs), field-programmable gate arrays (FPGAs), etc.) housed by a corresponding one of the host devices 101-104. For purposes of this disclosure, an object “instantiated” on a host device refers to any instance of software and/or hardware installed-on and/or housed-by the host device. The virtual edge router 100 may be managed by a virtual commander 160, which may be instantiated on a server 106. As used herein, the term “server” may refer to any component or collection of components maintained by a managed service provider. For example, the server 106 may correspond to a network of computing devices in a cloud computing data center or in a network of distributed data centers. As shown in FIG. 1A, the host devices 101, 102, 103, 104 and the server 106 comprise wide area network (WAN) interfaces 115, 125, 135, 145, 165 (respectively) configured to communicate over a wide area network 190.

The virtual forwarding units 110-130 are data plane entities of the virtual edge router 100. The terms “virtual forwarding unit,” “virtual data forwarding unit,” and “virtual forwarding switch” (vFS) are used interchangeably throughout this disclosure. As shown in FIG. 1B, the virtual forwarding units 110, 120, 130 are interconnected to one another via data tunnels 112, 113, 123 extending between WAN interfaces 115, 125, 135 of the host devices 101-103. The data tunnels 112, 113, 123 collectively form a data plane of the virtual edge router 100, and correspond to virtual data pathways through the WAN 190 that are secured by a network tunneling protocol. The virtual forwarding units 110, 120, 130 may be configured to forward data packets over the data tunnels 112, 113, 123. Data packets forwarded over the data tunnels 112, 113, 123 may be transported over the WAN 190 without exiting the data plane of the virtual edge router 100. In embodiments, the virtual forwarding units 110, 120, 130 and/or or the host devices 101-103 may include local area network (LAN) interfaces for communicating over a local area network with devices (e.g., computers, printers, etc.) in a remote office of an SMB client. The LAN interfaces of the virtual forwarding units 110, 120, 130 and/or or the host devices 101-103 may collectively represent LAN interfaces (or local/private interfaces) of the virtual edge router 100.

The virtual controller 140 is a control plane entity of the virtual edge router 100. The terms “virtual controller,” “virtual network controller,” and “virtual flow controller” (vFC) are used interchangeably throughout this disclosure. As shown in FIG. 1C, the virtual controller 140 is connected to each of the virtual forwarding units 110, 120, 130 via control tunnels 141, 142, 143 extending from the WAN interface 145 of the host device 104 to each of the WAN interfaces 115, 125, and 135 of the host devices 101-103. The control tunnels 141, 142, 143 collectively form a control plane of the virtual edge router 100. The virtual controller 140 may be configured to forward control packets over the control tunnels 141, 142, 143. Control packets forwarded over the control tunnels 141, 142, 143 may be transported over the WAN 190 without exiting the control plane of the virtual edge router 100. The virtual controller 140 may update and/or manage tables (e.g., routing, egress, etc.) in the virtual data forwarding units 110, 120, 130 via control signaling communicated over the control tunnel 141, 142, 143.

The virtual remote agents 116, 126, 136, 146 are management plane entities of the virtual edge router 100. The terms “remote agent” and “virtual remote agent” (vRA) are used interchangeably throughout this disclosure. The virtual commander 160 may be an internal management plane entity within the virtual edge router 100, or an external management device configured to manage the virtual edge router 100. The terms “virtual commander” and “virtual network commander” (vNetComm) are used interchangeably throughout this disclosure to refer to management applications in a management server. Notably, a single virtual network commander may contemporaneously serve as a management access point for multiple virtual edge routing networks. For instance, a single virtual network commander may be used to manage all (or a subset) of the edge routing networks maintained by a particular managed service provider. The respective virtual edge routing networks may be registered to the same SMB client or to different SMB clients, and may be subject to the same or to different service level agreements. In some embodiments, two or more managed service providers may share management resources (e.g., management server, virtual commander, etc.) in accordance with a shared services agreement. As shown in FIG. 1D, the virtual commander 160 is connected to each of the virtual remote agents 116, 126, 136, 146 via management signaling, which is transported over management tunnels 161, 162, 163 extending from the WAN interface 165 of the server 106 to each of the WAN interfaces 115, 125, 135, 145 of the host devices 101-104. The virtual remote agents 116, 126, 136, 146 and the virtual commander 160 may be configured to forward management packets over the management tunnels 161, 162, 163. Management packets forwarded over the management tunnels 161, 162, 163 may be transported over the WAN 190 without exiting the management plane of the virtual edge router 100.

In some embodiments, a virtual controller may be co-located with a virtual forwarding unit in a common host device. FIG. lE illustrates an embodiment virtual edge router 109 in which the virtual controller 140 and is co-located with a virtual forwarding unit 150 in a host device 105. The host device 105 includes a virtual remote agent 136 configured to manage the virtual controller 140 and the virtual forwarding unit 150. As shown, the virtual controller 140 and the virtual forwarding unit 150 share a common WAN interface 155 of the remote device, and an internal control path 145 extends between the virtual controller 140 and the virtual forwarding unit 150. While the virtual edge router 109 includes data, control, and management tunnels, those tunnels have been omitted from FIG. lE for purposes of clarity and concision.

The data tunnels 112, 113, 123, control tunnels 141, 142, 143, and management tunnels 161, 162, 163 (referred to collectively as “tunnels”) correspond to virtual pathways through the WAN 190 that are secured through one or more network tunneling protocols. In one embodiment, the same tunneling protocol is used for each of the tunnels 112-113, 123, 141-143, 161-163. In another embodiment, different tunneling protocols are used for different tunnel classifications. For example, a different tunneling protocol may be used for the data tunnels 112-113, 123 than for the control tunnels 141-143. In yet other embodiments, different tunneling protocols are used for tunnels within the same tunnel classification. For example, a different tunneling protocol may be used for the data tunnel 112 than for the data tunnel 123. Tunneling protocols may use data encryption to securely transport payloads over the WAN 190. The WAN 190 may include any wide area network or collection of wide area networks. In an embodiment, the WAN 190 corresponds to a public internet. In another embodiment, the WAN 190 corresponds to a private internet protocol (IP) network. In yet other embodiments, the WAN 190 includes a collection of public and private IP networks. The WAN 190 is not limited to IP networks, and may include networks operating under any other network delivery protocol. Unless otherwise specified, the term “wide area network” is used loosely throughout this disclosure to refer to any network (or collection of networks) that serve to interconnect two or more local area networks (LANs).

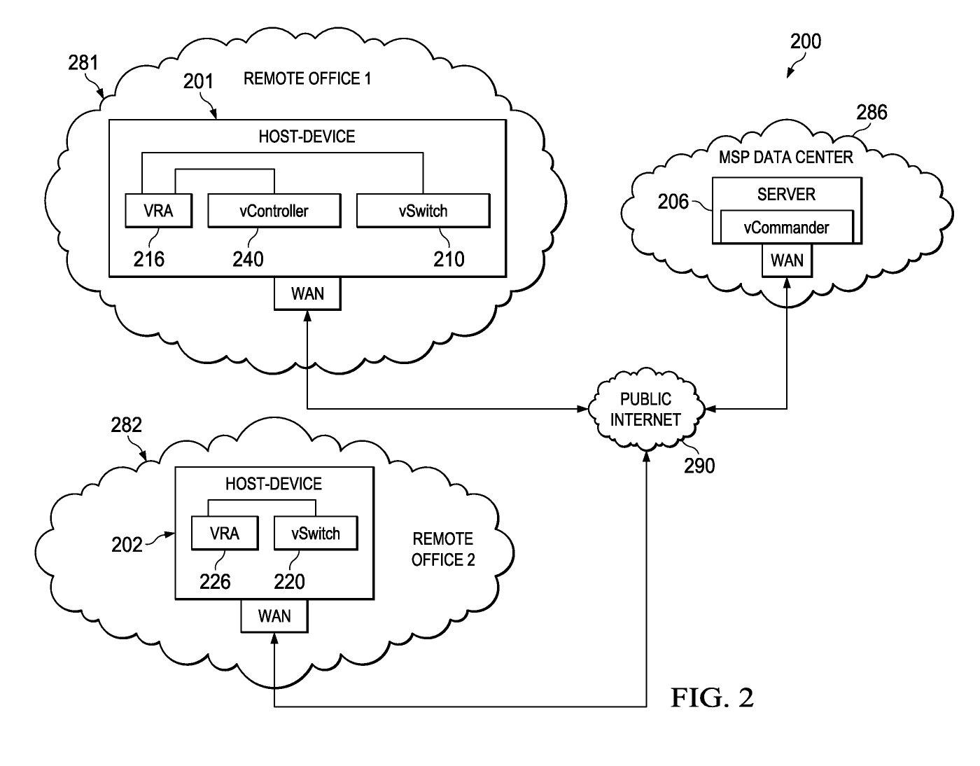

In some embodiments, a virtual commander may be positioned in a management facility (or network of facilities) maintained by a managed service provider (MSP), while virtual components (e.g., virtual forwarding units, virtual controller, virtual remote agent, etc.) may be instantiated on host devices distributed across multiple remote office locations of an SMB client. FIG. 2 illustrates a virtual edge router 200 comprising a virtual data forwarding unit 210, a virtual remote agent 216, and a virtual controller 240 instantiated on a host-device 201 in a remote office 281, and a virtual data forwarding unit 220 and a virtual remote agent 226 instantiated on a host-device 202 in a remote office 282. The remote offices 281, 282 are interconnected with one another, as well as with a server 206 in a managed service provider data center 286, via a public internet 290. As discussed herein, remote office locations housing a virtual controller are referred to as head-office locations, while remote office locations housing a virtual forwarding switch (but not a virtual network controller) are referred to as branch-office locations.

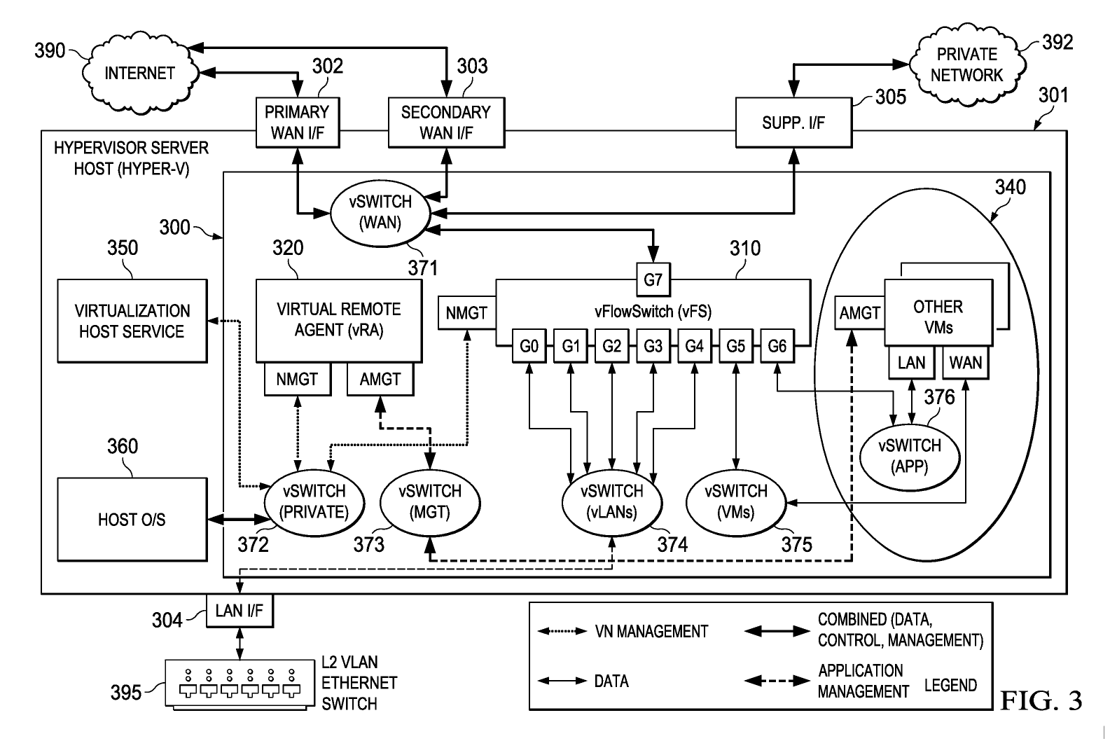

Embodiments of this disclosure provide virtual architectures for distributed host devices. FIG. 3 illustrates an embodiment virtual architecture 300 for a distributed host device 301 positioned in a branch office of a SMB client. As shown, the host device 301 includes a primary WAN interface 302 and a secondary WAN interface 303 configured to communicate over the internet 390, a LAN interface 304 configured to communicate with internal destinations via a virtual LAN (VLAN) Ethernet switch 395, and a supplemental interface 305 configured to communicate over a private network, e.g., a multi-protocol label switching (MPLS) network 392, etc. The host device 301 includes a virtual flow switch 310, a virtual remote agent 320, a plurality of virtual machines 340, and a virtualization host service 350, which are collectively referred to as virtual components 310-350. The virtual components 310-350 and a host operating system 360 are interconnected via links and virtual switches 371-376. These links are classified as combined links, data links, virtual network (VN) management links, and application management links, as indicated by the legend. Other link classifications may also be included in the virtual architecture 300.

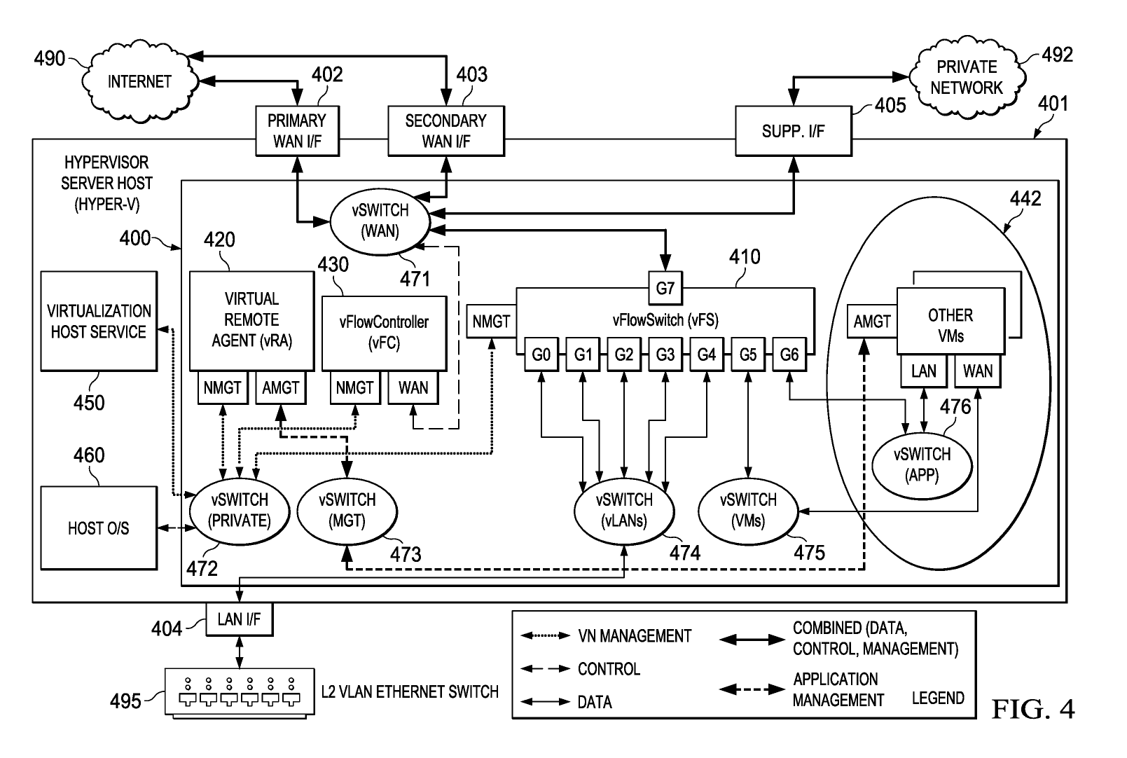

FIG. 4 illustrates an embodiment virtual architecture 400 for a distributed host device 401 positioned in a head office of an SMB client. As shown, the host device 401 includes a primary WAN interface 402 and a secondary WAN interface 403 configured to communicate over the internet 490, a LAN interface 404 configured to communicate with internal destinations via a virtual LAN (VLAN) Ethernet switch 495, and a supplemental interface 405 configured to communicate over a private network 492, e.g., a multi-protocol label switching (MPLS) network, etc. The host device 401 includes a virtual flow switch 410, a virtual remote agent 420, a virtual controller 430, a plurality of virtual machines 440, and a virtualization host service 450, which are collectively referred to as virtual components 410-450. The virtual components 410-450 and a host operating system 460 are interconnected via links and virtual switches 471-476. The links interconnecting the virtual components 410-460 and the host operating system 460 are classified as combined links, data links, control links, VN management links, and application management links, as indicated by the legend. Other link classifications may also be included in the virtual architecture 400.

The combined data links in the virtual architectures 300, 400 may include each of the other link classifications. For example, the combined data links in the virtual architectures 300, 400 may include a multiplexed combination of data links, control links, virtual network (VN) management links, and application management links. The data links may carry data in the virtual edge network. The data may include incoming data communicated from an external source (e.g., from the internet 390, 490) to an internal destination (e.g., device connected to Ethernet switch 395, 495), as well as outgoing data communicated from an internal source to an external destination. The data may also include internal data communicated from an internal source to an internal destination. The control links may carry control signaling in the virtual edge network. Control signaling may include signaling communicated from the virtual controller 430 to other virtual machines in the virtual edge network, e.g., the virtual flow switches 310, 410, etc., and vice-versa. The VN management links and application management links may carry management signaling in the virtual edge network. Management signaling may include signaling communicated from a virtual commander to one of the virtual remote agents 320, 420, as well as signaling instructions communicated from the virtual remote agents 320, 420 to other virtual machines in the virtual edge network.

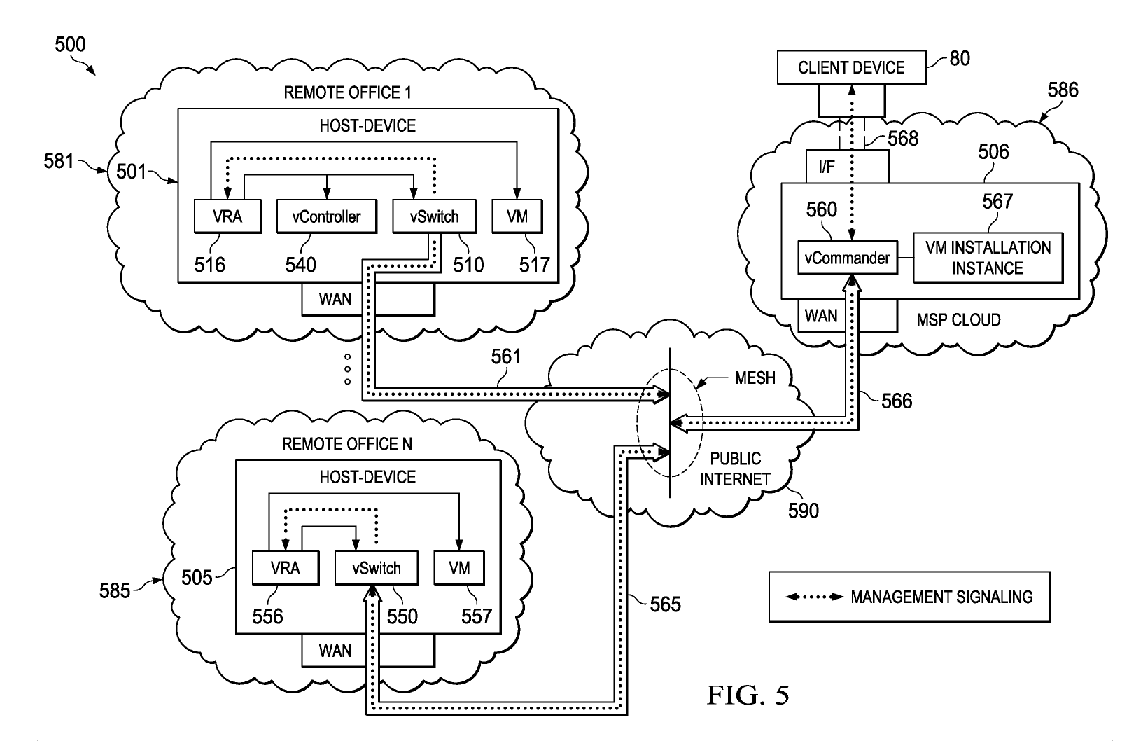

Aspects of this disclosure provide mechanisms for remotely configuring virtual machines on distributed host devices. FIG. 5 illustrates a virtual edge routing architecture 500 adapted for remote configuration of virtual machines on distributed host devices in remote offices of an SMB client. As shown, the virtual edge routing architecture 500 includes host-device 501-505 positioned in remote offices 581-585 of an SMB client, a server 506 positioned in an MSP cloud 586, and a set of management tunnels 561-566. The host device 501 includes a virtual data forwarding unit 510, a virtual remote agent 516, a virtual machine 517, and a virtual controller 540, while the host device 505 includes a virtual data forwarding unit 550, a virtual remote agent 556, and a virtual machine 557. The server 506 includes a virtual commander 560 and a virtual installation instance 567.

The set of management tunnels 561-566 interconnect the virtual commander 560 with the virtual data forwarding units 510, 550, and are configured to carry management signaling from the virtual commander 560 to the virtual remote agents 516, 556, and vice-versa. The management tunnels 561-565 may be persistent core channels (e.g., tunnels established by beacons) or temporary access tunnels (e.g., remote access tunnels established during a remote access session of the client device 580). The management tunnels 561-565 may be meshed (or otherwise multiplexed) together to form the management tunnel 566. As such, the management tunnel 566 may carry unicast, multicast, or broadcast management signaling communicated from the virtual commander 560 to one or more of the virtual remote agents 516, 556. During remote access sessions, a management tunnel 568 may carry management signaling from a client device 580 to the virtual commander 560, and vice-versa. The management tunnel 566 may be a remote access tunnel or a persistent channel.

Management signaling communicated over the management tunnels 561-565 may prompt the virtual remote agents 516, 556 to configure one or more virtual machines on the host devices 501, 505. For example, management signaling communicated over the management tunnel 561 may prompt the virtual remote agent 516 to re-configure the virtual forwarding unit 510, the virtual controller 540, or the virtual machine 517. Likewise, management signaling communicated over the management tunnel 565 may prompt the virtual remote agent 556 to re-configure the virtual forwarding unit 550 or the virtual machine 557. In an embodiment, the management signaling communicated over the management tunnel 565 prompts the virtual remote agent 556 to configure the virtual data forwarding unit 510 to perform a new processing task (e.g., packet filtering, queuing, etc.) on incoming and/or outgoing packets,

Management signaling communicated over the management tunnels 561-565 may coordinate instantiation of virtual machines 516, 567 on the host devices 501, 505 based on the virtual machine installation instance 567. For example, the virtual commander 560 may broadcast or multicast management signaling over the management tunnels 561-565 to the virtual remote agents 516, 556. The broadcast or multicast management signaling may carry management instructions corresponding to the virtual machine installation instance 567, and may trigger the virtual remote agents 516, 556 to build/compile the virtual machines 517, 557 based on the virtual machine installation instance 567. Unicast signaling can also be used to trigger instantiation of virtual machines 516, 567 on the host devices 501, 505 at different times. In one example, management signaling is broadcast or multicast to a set of existing host devices upon creation of the virtual machine installation instance 567. Thereafter, the management signaling is communicated to newly added host devices upon power up. For example, the virtual machine installation instance 567 may be created after initializing the host device 501 but before adding the host device 505 to the virtual network, in which case the virtual machine 517 is established upon creation of the virtual machine installation instance 567, and the virtual machine 557 is established upon powering-up the host device 505.

Management signaling communicated over the management tunnels 561-565 may coordinate remote re-configuration of virtual machines 517, 557 based on modifications to the virtual machine installation instance 567. For example, the virtual commander 560 may broadcast or multicast a differential update instruction over the management tunnels 561-565 to the virtual remote agents 516, 556. The differential update instruction may specify updates to the virtual machine installation instance 567 at the server 506, and may prompt the virtual remote agents 516, 556 to modify the virtual machines 517, 557 based on the specified updates to the virtual machine installation instance 567. In an embodiment, the updates are differential updates, and indicate modifications to the virtual machine installation instance 567 without specifying aspects/characteristics of the virtual machine installation instance 567 that have stayed the same. For example, if a new processing task was added to the virtual machine installation instance 567 without modifying existing tasks, then the differential update may specify the new task without specifying the previously existing tasks. This may reduce overhead and allow for quicker implementation of differential updates. Reconfiguration of the virtual machine installation instance 567 may be performed by the virtual commander 560 unilaterally or based on directions from a user of the client device 580, e.g., via a graphical user interface (GUI) or otherwise. Management signaling communicated over the management tunnels 561-565 may coordinate remote re-configuration of the virtual forwarding units 510, 550 in a similar manner.

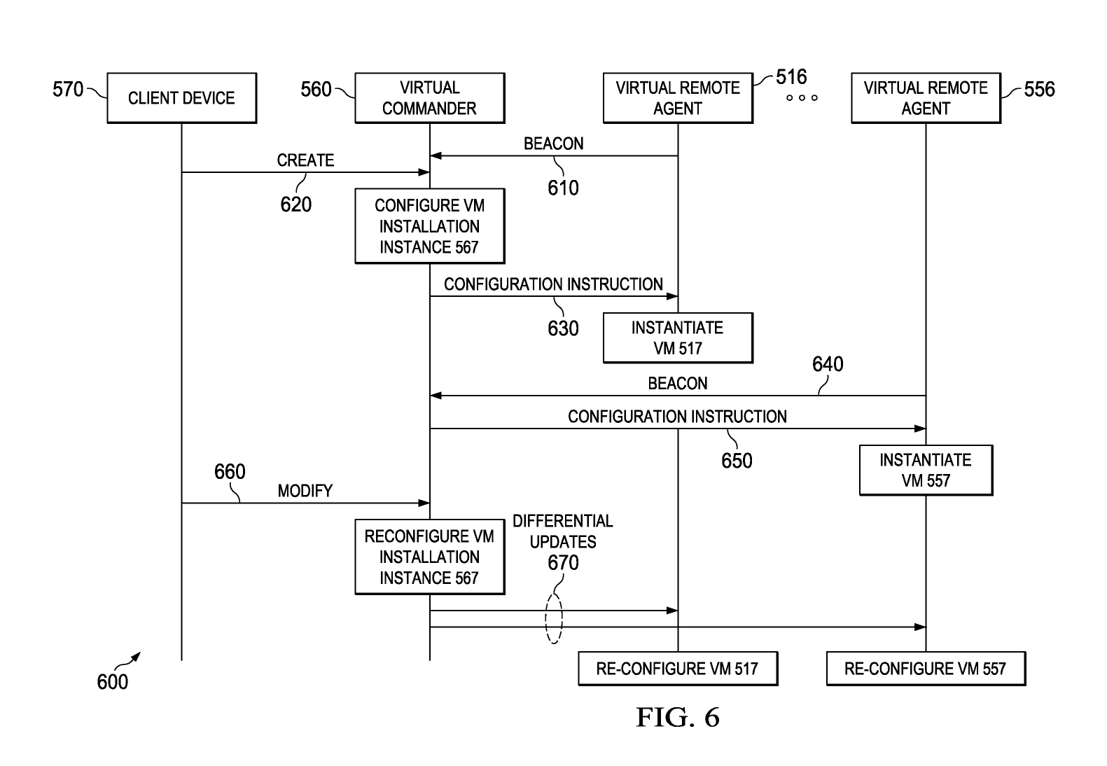

Aspects of this disclosure provide a communications protocol for remotely configuring a virtual machine on a distributed host device. FIG. 6 illustrates an embodiment communications sequence 600 for instantiating the virtual machines 517, 557 on the host devices 501, 505. As shown, the embodiment communications sequence 600 begins when the virtual remote agent 516 sends a beacon 610 to the virtual commander 560. The beacon 610 is triggered by powering up the distributed host device 501, and serves to integrate the host device 501 into the virtual edge routing architecture 500. In an embodiment, the host device 501 is the first host device in a virtual edge routing network of an SMB client, and the beacon 610 serves to trigger establishment and/or activation of that virtual edge routing network of the SMB client. Sometime thereafter, the virtual commander 560 receives a create message 620 from the client device 570, and builds the virtual machine installation instance 567 on the server 506. After building the virtual machine installation instance 567, the virtual commander 560 communicates a configuration instruction 630 to the virtual remote agent 516, thereby prompting the virtual remote agent 516 to instantiate the virtual machine 517 on the distributed host device 501.

At a subsequent period in time, the virtual host device 505 is powered up in a remote office of the SMB client, which prompts the virtual remote agent 556 to communicate the beacon 640 to the virtual commander 560. The beacon 640 serves to integrate the host device 505 into the virtual edge routing architecture 500. In this instance, a default setting of the SMB client's virtual edge routing network is to install a new virtual machine on newly introduced host devices. Hence, a configuration instruction 650 is autonomously generated by the virtual commander 560, and then sent to the virtual remote agent 556. The configuration instruction 650 prompts the virtual remote agent 556 to instantiate the virtual machine 557 on the distributed host device 505.

After some more time has passed, the client device 570 sends a modification instruction 660 to the virtual commander 560, which prompts the virtual commander 560 to reconfigure the virtual machine installation instance 667 at the server 606. Upon reconfiguring the virtual machine installation instance 667, the virtual commander 560 broadcasts differential updates 670 to the virtual remote agents 516, 556. The differential updates 670 may indicate modifications to the virtual machine installation instance 667, and may prompt the virtual remote agents 516, 556 to reconfigure the virtual machines 517, 557 to reflect those modifications.

A similar protocol can be used to modify/reconfigure the virtual forwarding units 510, 550. For example, the configuration instruction 650 may instruct the virtual remote agent 516 to reconfigure the virtual forwarding unit 510 and/or the virtual controller 540. Likewise, the differential updates 670 may coordinate reconfiguration of the virtual forwarding units 510, 550. A similar protocol may be used to re-route virtual paths between virtual machines instantiated on the host devices 501, 505. For example, the configuration instruction 650 could instruct the virtual remote agent 516 to create, remove, or modify virtual paths between two or more virtual machines on the host devices 501. In a similar way, the differential updates 670 may coordinate the re-routing of virtual paths between virtual machines on the host devices 501, 505.

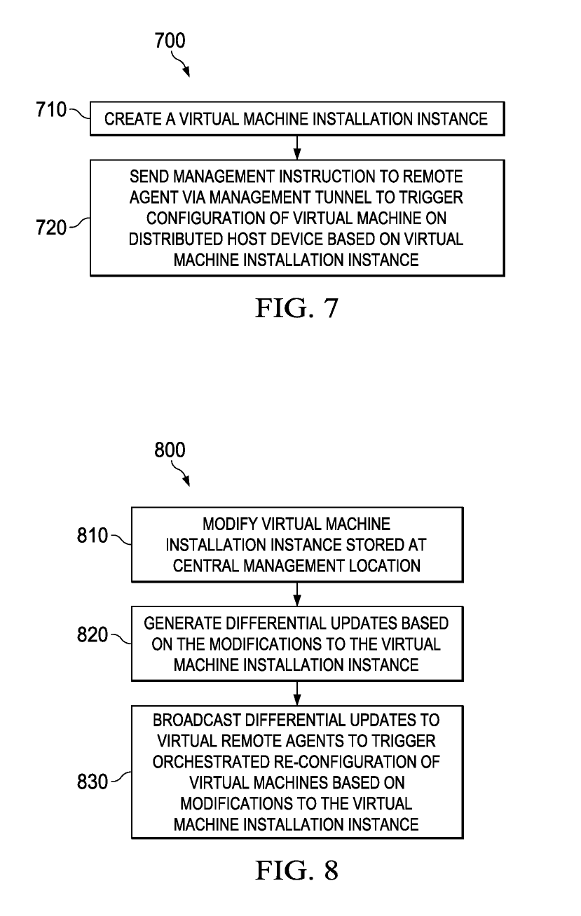

Aspects of this disclosure provide techniques for remotely configuring virtual machines on distributed host devices. FIG. 7 illustrates a method 700 for remotely triggering the instantiation of a virtual machine on a distributed host device, as may be performed by a management server. As shown, the method 700 begins with step 710, where the management server creates a virtual machine installation instance. The virtual machine installation instance may be stored on a device (e.g., a server) in an MSP data center. Subsequently, the method 700 proceeds to step 720, where the management server sends a management instruction to the remote agent via the management tunnel to trigger configuration of a virtual machine on the distributed host device based on the virtual machine installation instance. In some embodiments, the management instruction is communicated over a previously existing management tunnel (e.g., core channel, etc.). In other embodiments, the management instruction is communicated over a temporary tunnel (e.g., remote access tunnel).

FIG. 8 illustrates a method 800 for remotely triggering the modification of virtual machines instantiated on distributed host devices, as may be performed by a management server. As shown, the method 800 begins with step 810, where the management server modifies a virtual machine installation instance stored on a device in an MSP data center. Next, the method 800 proceeds to step 820, where the management server generates differential updates based on the modifications to the virtual machine installation instance. Subsequently, the method 800 proceeds to step 830, where the management server broadcasts the differential updates to virtual remote agents to trigger orchestrated re-configuration of virtual machines based on the modifications to the virtual machine installation instance.

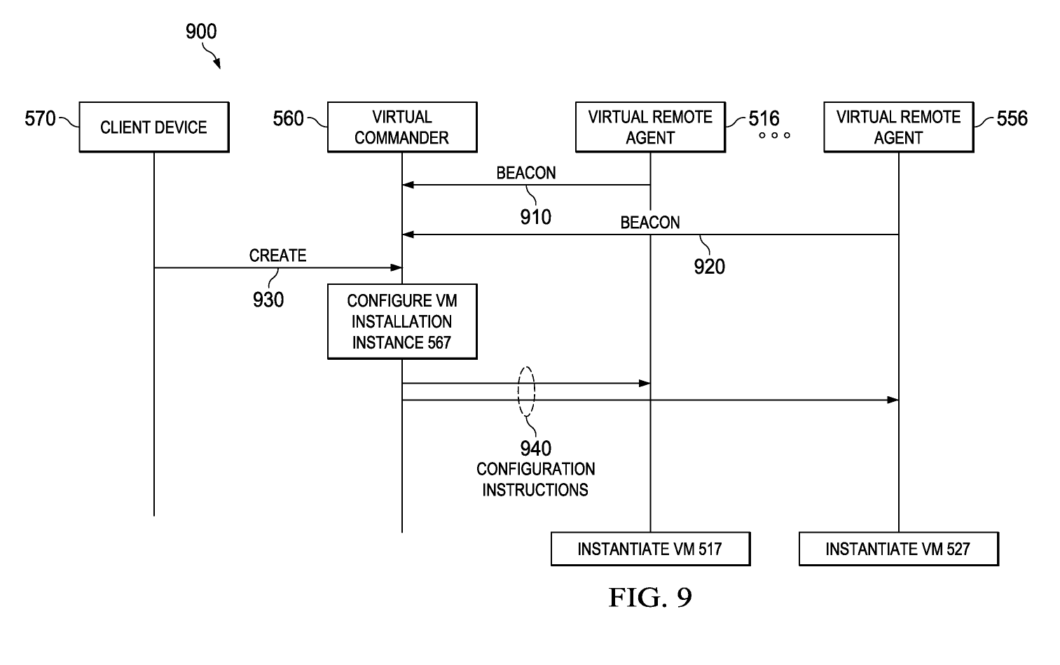

Aspects of this disclosure also provide the ability to coordinate instantiation of virtual machines across multiple host devices. FIG. 9 illustrates an embodiment communications sequence 900 for coordinating the instantiation of the virtual machines 517, 557 on the host devices 501, 505. As shown, the embodiment communications sequence 900 begins when the virtual remote agents 516, 556 send the beacons 910, 920 to the virtual commander 560. The beacons 910, 920 serve to integrate the host devices 501, 505 into the virtual edge routing architecture 500. Thereafter, the virtual commander 560 receives a create message 930 from the client device 570, and builds the virtual machine installation instance 567 on the server 506. After building the virtual machine installation instance 567, the virtual commander 560 broadcasts configuration instructions 940 to the virtual remote agents 516, 556, which prompts the virtual remote agents 516, 556 to instantiate the virtual machines 517, 557 on the distributed host devices 501, 505.

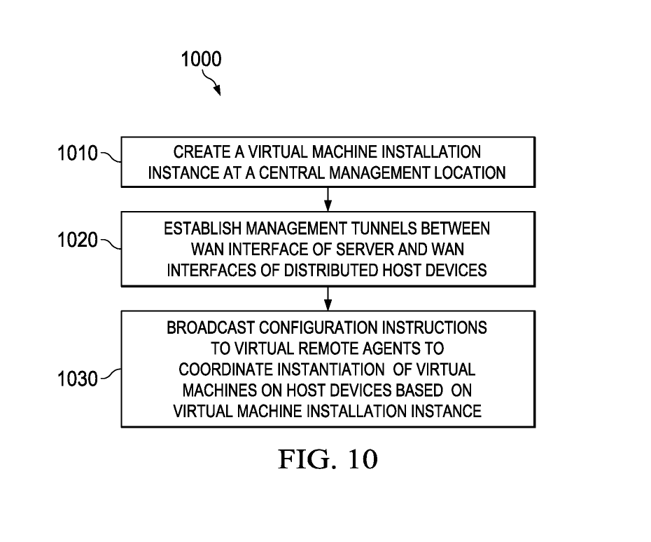

Aspects of this disclosure provide techniques for remotely configuring virtual machines on distributed host devices. FIG. 10 illustrates a method 1000 for remotely coordinating instantiation of virtual machines on two or more distributed host devices, as may be performed by a management server. As shown, the method 1000 begins with step 1010, where the management server creates a virtual machine installation instance. Next, the method 1000 proceeds to step 1020, where the management server establishes management tunnels between a WAN interface of the management server and WAN interfaces of the distributed host devices. Subsequently, the method 1000 proceeds to step 1030, where the management server sends a management instruction to remote agents instantiated on the distributed host devices via the management tunnels to coordinate instantiation of virtual machines on the distributed host devices. In some embodiments, the management instruction is communicated over existing management tunnels. In some embodiments, a management server or virtual network commander may broadcast a management instruction over management tunnels of two or more virtual edge routing networks. This may allow an MSP to orchestrate a system wide update across different virtual edge routing networks.

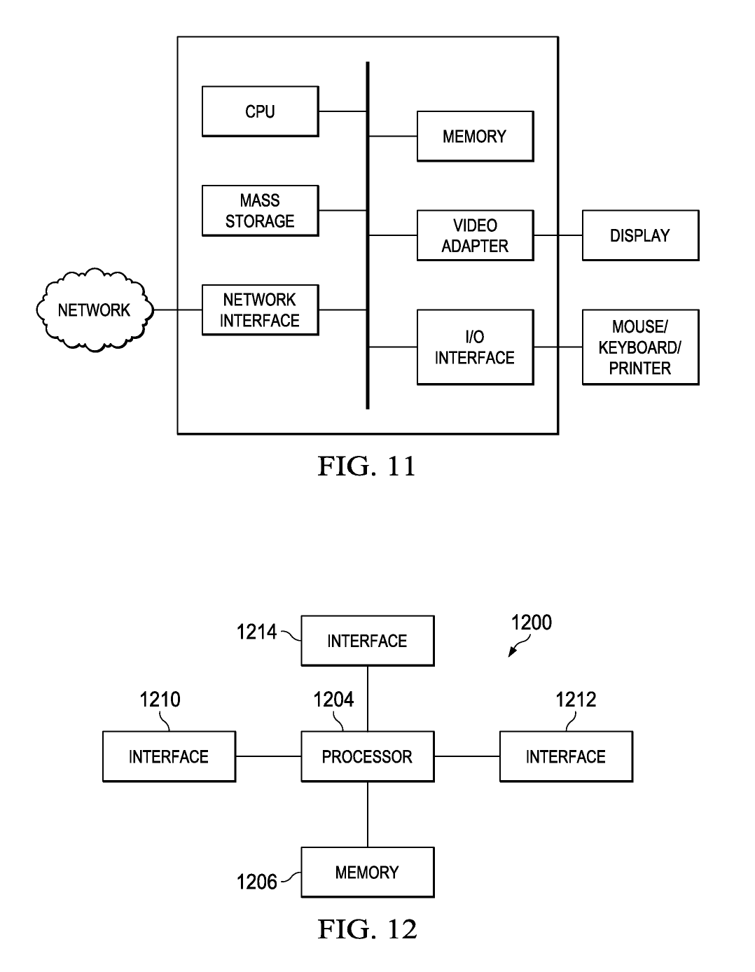

FIG. 11 illustrates a block diagram of a processing system that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system may comprise a processing unit equipped with one or more input/output devices, such as a speaker, microphone, mouse, touchscreen, keypad, keyboard, printer, display, and the like. The processing unit may include a central processing unit (CPU), memory, a mass storage device, a video adapter, and an I/O interface connected to a bus.

The bus may be one or more of any type of several bus architectures including a memory bus or memory controller, a peripheral bus, video bus, or the like. The CPU may comprise any type of electronic data processor. The memory may comprise any type of system memory such as static random access memory (SRAM), dynamic random access memory (DRAM), synchronous DRAM (SDRAM), read-only memory (ROM), a combination thereof, or the like. In an embodiment, the memory may include ROM for use at boot-up, and DRAM for program and data storage for use while executing programs.

The mass storage device may comprise any type of storage device configured to store data, programs, and other information and to make the data, programs, and other information accessible via the bus. The mass storage device may comprise, for example, one or more of a solid state drive, hard disk drive, a magnetic disk drive, an optical disk drive, or the like.

The video adapter and the I/O interface provide interfaces to couple external input and output devices to the processing unit. As illustrated, examples of input and output devices include the display coupled to the video adapter and the mouse/keyboard/printer coupled to the I/O interface. Other devices may be coupled to the processing unit, and additional or fewer interface cards may be utilized. For example, a serial interface such as Universal Serial Bus (USB) (not shown) may be used to provide an interface for a printer.

The processing unit also includes one or more network interfaces, which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like.

FIG. 12 illustrates a block diagram of an embodiment of a communications device 1200, which may be equivalent to one or more devices discussed above. The communications device 1200 may include a processor 1204, a memory 1206, and a plurality of interfaces 1210, 1212, 1214, which may (or may not) be arranged as shown in FIG. 12. The processor 1204 may be any component capable of performing computations and/or other processing related tasks, and the memory 1206 may be any component capable of storing programming and/or instructions for the processor 1204. The interfaces 1210, 1212, 1214 may be any component or collection of components that allows the communications device 1200 to communicate with other devices.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed:

1. A method for remotely managing distributed hosts of a virtual edge router, the method comprising:
establishing a management tunnel between a wide area network (WAN) interface of a management server and a wide area network (WAN) interface of a distributed host device, wherein the management tunnel extends through a public internet; and
sending, by a management server, a management instruction over the management tunnel to a virtual remote agent instantiated on the distributed host device, wherein the management instruction prompts the virtual remote agent to autonomously configure at least one virtual machine on the distributed host device without direct interaction between a user and the distributed host device.

2. The method of claim 1, wherein the management instruction prompts the virtual remote agent to instantiate one or more virtual machines on the distributed host device.

3. The method of claim 1, wherein the management instruction prompts the virtual remote agent to create, remove, or modify a virtual path between two or more virtual machines instantiated on the distributed host device.

4. The method of claim 1, wherein the management instruction prompts the virtual remote agent to re-configure a virtual data forwarding unit instantiated on the distributed host device, the virtual data forwarding unit being located on a data plane of the virtual edge router.

5. The method of claim 4, wherein the management instruction prompts the virtual remote agent to configure the virtual data forwarding unit to perform a new processing task on incoming or outgoing packets communicated via the WAN interface of the distributed host device.

6. The method of claim 5, wherein the new processing task comprises one or a combination of packet filtering, quality of service (QoS) queuing, firewall protection, and data encryption.

7. The method of claim 1, wherein establishing the management tunnel between the WAN interface of the management server and the WAN interface of the distributed host device comprises:
receiving, by the management server, a homing beacon from the virtual remote agent via the WAN interface of the management server, wherein the homing beacon carries authentication information;
determining whether the authentication information is valid; and
establishing the management tunnel when the authentication information is valid.

8. The method of claim 7, wherein the homing beacon is communicated by the virtual remote agent without any previous signaling between the virtual remote agent and the management server.

9. The method of claim 1, wherein the management server comprises a system of network devices maintained by a managed service provider (MSP).

10. A management server comprising:
a wide area network (WAN) interface; and
at least one processor adapted to perform as a management server in a virtual edge router, wherein the at least one processor is configured to establish a management tunnel between the WAN interface of the management server and a WAN interface of a distributed host device, and to send a management instruction over the management tunnel to a virtual remote agent instantiated on the distributed host device,
wherein the management instruction prompts the virtual remote agent to autonomously configure at least one virtual machine on the distributed host device without direct interaction between a user and the distributed host device.

11. The management server of claim 10, wherein the management instruction prompts the virtual remote agent to instantiate one or more virtual machines on the distributed host device.

12. The management server of claim 10, wherein the management instruction prompts the virtual remote agent to create, remove, or modify a virtual data path between two or more virtual machines instantiated on the distributed host device.

13. The management server of claim 10, wherein the management server comprises a system of network devices maintained by a managed service provider (MSP).

14. A method for coordinating establishment of virtual machines at distributed locations of a virtual edge network, the method comprising:
creating, by a management server, a single virtual machine installation instance at a management server; and
broadcasting a management instruction over management tunnels of the virtual edge network to a set of virtual remote agents, wherein each virtual remote agent in the set of virtual remote agents is instantiated on a different one of a plurality of distributed host devices, wherein the broadcast management instruction specifies instantiation instructions for the single virtual machine installation instance, and
wherein the broadcast management instruction prompts each virtual remote agent in the set of virtual remote agents to autonomously instantiate a virtual machine on a corresponding one of the plurality of distributed host devices based on the single virtual machine installation instance.

15. The method of claim 14, wherein the set of virtual remote agents includes at least a first virtual remote agent instantiated on a first distributed host device and a second virtual remote agent instantiated on a second distributed host device, and
wherein the broadcast management instruction coordinates instantiation of a first virtual machine on the first distributed host device by the first virtual remote agent with the instantiation of a second virtual machine on the second distributed host device by the second virtual remote agent.

16. The method of claim 15, wherein the first distributed host device and the second host device are positioned in geographically distinct remote office locations.

17. The method of claim 14, wherein the management tunnels extend over a public internet.

18. A method for coordinating updates to virtual machines at distributed locations of a virtual edge network, the method comprising:
identifying, by a management server, a single virtual machine installation instance stored at the management server, wherein the single virtual machine installation instance corresponds to a set of virtual machines each of which being instantiated on a different one of a plurality of distributed host devices;
reconfiguring the single virtual machine installation instance at the management server, thereby obtaining a reconfigured virtual machine installation instance; and
broadcasting a management instruction over management tunnels of the virtual edge network to a set of virtual remote agents, wherein each virtual remote agent in the set of virtual remote agents is instantiated on a different one of the plurality of distributed host devices, wherein the broadcast management instruction specifies reconfiguration instructions for the reconfigured virtual machine installation instance, and
wherein the broadcast management instruction prompts each virtual remote agent in the set of virtual remote agents to autonomously update a corresponding virtual machine in the set of virtual machines.

19. The method of claim 18, wherein the set of virtual machines includes at least a first virtual remote agent instantiated on a first distributed host device and a second virtual remote agent instantiated on a second distributed host device, and
wherein the broadcast management instruction coordinates updating of a first virtual machine on the first distributed host device by the first virtual remote agent with the updating of a second virtual machine on the second distributed host device by the second virtual remote agent.

20. The method of claim 18, wherein reconfiguring the single virtual machine installation instance at the management server comprises:
prompting a user to modify a graphical representation of the single virtual machine installation instance displayed on a graphical user interface of a client device; and
reconfiguring the single virtual machine installation instance in accordance with modifications to the graphical representation displayed on the graphical user interface.

21. The method of claim 18, further comprising:
contemporaneously broadcasting the management instruction over management tunnels in two or more virtual edge routing networks, wherein the broadcast management instruction prompts virtual remote agents to autonomously update virtual machines in each of the two or more virtual edge routing networks.

22. The method of claim 21, wherein at least some of the two or more virtual edge routing networks are registered to different clients.
